(19) United States
(12) Patent Application Publication
(10) Pub. No.: US 2024/0243306 A1
(43) Pub. Date: Jul. 18, 2024

(54) CONVEYING DEVICE FOR A FUEL CELL SYSTEM FOR CONVEYING AND/OR RECIRCULATING A GASEOUS MEDIUM, IN PARTICULAR HYDROGEN

(71) Applicant: Robert Bosch GmbH, Stuttgart (DE)

(72) Inventors: Martin Katz, Stuttgart (DE); Benedikt Leibssle, Stuttgart (DE); Jochen Wessner, Esslingen (DE)

(21) Appl. No.: 18/562,577

(22) PCT Filed: Apr. 27, 2022
(86) PCT No.: PCT/EP2022/061235

§ 371 Date: Nov. 20, 2023

(30) Foreign Application Priority Data
Jun. 4, 2021 (DE) 10 2021 205 685.7

(51) Int. Cl. H01M 8/04089; H01M 8/04082; H01M 8/04111

(52) U.S. Cl. CPC H01M 8/04097; H01M 8/04111; H01M 8/04201

(57) ABSTRACT

The invention relates to a conveying device (1) for a fuel cell system (31) for conveying and/or recirculating a gaseous medium, in particular hydrogen, comprising: a side channel compressor (2), the conveying device (1) being driven at least partially by means of a metering valve (6) having a propulsion jet (12) of a pressurized gaseous medium, and the pressurized gaseous medium being fed to the side channel compressor (2) at least indirectly by means of the metering valve (6); a compressor chamber (30) which extends around an axis of rotation (23) in the housing (17) and has at least one circumferential side channel (19); an impeller (14) which is located in the housing (17), is rotatable about the axis of rotation (23) and is driven by the drive (10), the side channel compressor (2) having a housing (17) with a gas inlet opening (20) formed on the housing (17) and a gas outlet opening (22), which are fluidically connected to one another via the compressor chamber (30), in particular the at least one first side channel (19).

According to the invention, the gaseous medium is fed by means of the metering valve (6) to the side channel compressor (2) via the impeller (14), the feed taking place at least almost in the direction of the axis of rotation (23) on the side of the impeller (14) facing away from the drive (10).

### BACKGROUND

The present invention relates to a conveying device for a fuel cell system for conveying and/or recirculating a gaseous medium, in particular hydrogen, which is in particular intended for application in vehicles with a fuel cell drive.

In the automotive sector, in addition to liquid fuels, gaseous fuels will also play an increasing role in the future. In particular in vehicles with fuel cell drive, hydrogen gas flows need to be controlled. The gas flows are no longer discontinuously controlled as with the injection of liquid fuel, but rather the gas is withdrawn from at least one high-pressure tank and directed to the conveying device via a supply line of a medium-pressure line system. This conveying device feeds the gas to a fuel cell via a connecting line of a low-pressure line system.

A conveying device for a fuel cell system for conveying and/or recirculating a gaseous medium, in particular hydrogen, comprising a side channel compressor, with a jet pump driven by a propulsion jet of a pressurized gaseous medium and with a metering valve, is known from DE 10 2017 222 390 A1. The pressurized gaseous medium is fed to the jet pump by means of the metering valve, wherein an anode output of a fuel cell is fluidically connected to an input of the conveying device, and wherein an output of the conveying device is fluidically connected to an anode input of the fuel cell,

The conveying device known from the fuel cell system known from DE 10 2017 222 390 A1 can in each case have certain disadvantages. The components of the conveying device, in particular the side channel compressors, an HGI and the jet pump are connected at least in part to each other and/or to the fuel cell and/or to other components of the conveying device by means of fluidic connections in the form of pipes and optionally an additional distribution plate with internal channels. The components are at least partially provided as separate assemblies, which are connected to each other by means of pipes. On the one hand, this results in many flow deflections and thus flow losses. This reduces the efficiency of the conveying device.

On the other hand, arranging the components of the metering valve and/or jet pump and/or side channel compressor as separate assemblies has the disadvantage that they form a large overall surface area in relation to the assembly space and/or geometric volume. This favors rapid cooling, in particular when the entire vehicle is stationary for long periods, which can lead to increased formation of ice bridges and thus increased damage to the components and/or a fuel cell system, which in turn can lead to reduced reliability and/or service life of the conveying device and/or fuel cell system. A further disadvantage is also poor cold start properties of the metering valve and/or jet pump and/or side channel compressors and/or the fuel cell system and/or the overall vehicle, components as heating energy and/or thermal energy must each be individually introduced into each of the side channel compressor and/or jet pump and/or metering valve components, wherein the components are arranged at a distance from each another and thus each component must be heated separately, in particular at temperatures below 0° Celsius, in order to eliminate potential ice bridges.

Furthermore, the side channel compressor, jet pump and metering valve components must each be provided with their own housing, which leads to high manufacturing costs and/or material costs.

### SUMMARY

According to the present invention, a conveying device for a fuel cell system is proposed for conveying and/or recirculating a gaseous medium, in particular hydrogen, wherein the hydrogen is referred to below as H₂. The conveying device comprises a side channel compressor, wherein the conveying device is at least partially driven by means of a metering valve having a propulsion jet of a pressurized gaseous medium, wherein the pressurized gaseous medium is fed at least indirectly to the side channel compressor by means of the metering valve. The side channel compressor comprises a housing with a compressor chamber located in the housing, which has a circumferential first side channel and with an impeller located in the housing, which is arranged rotatably about an axis of rotation and is driven by a drive. Furthermore, the housing, in particular in the area of the first side channel, comprises a gas inlet opening and a gas outlet opening fluidically connected to one another via the compressor chamber. The gaseous medium can in particular be a propellant medium that comes from a tank.

The conveying device is configured such that the gaseous medium is fed by means of the metering valve to the side channel compressor via the impeller, wherein the feed takes place at least almost in the direction of the axis of rotation on the side of the impeller facing away from the drive. In this way, the advantage can be achieved that a compact design of the conveying device can be brought about, as the drive is arranged on the opposite side of the impeller from the metering valve in the direction of the axis of rotation. In addition, the component costs and/or the assembly cost of the side channel compressor can be reduced, as the feeding of the gaseous medium by means of the metering valve does not need to be from the side of the drive, resulting in a higher complexity of the components and/or the parts, for example by means of a hollow shaft, which is used to transfer torque from the drive to the impeller and to pass and feed the gaseous medium to the side channel compressor. This leads to a cost saving for the entire conveying device. In addition, in this way the flow paths between the metering valve and the side channel compressor can be shortened, resulting in a reduction of the flow losses of the gaseous medium and thus increased efficiency of the entire conveying assembly.

According to an advantageous configuration of the conveying device, the gaseous medium is fed from the metering valve into the area of an axial opening of the impeller, wherein the axial opening extends in particular around the axis of rotation in a disc-shaped manner. In this way, the gaseous medium can be introduced directly from the metering valve into the impeller without the need for further components, for example in the form of pipelines. This leads to reduced material costs and assembly costs of the conveying device being reduced. In addition, no seal is necessary, for example for a pipe system and/or a mechanical interface between the metering valve, so that a low-wear and friction-free possibility for feeding the gaseous medium to the impeller and/or side channel compressor can take place. This provides the advantage of an increased service life of the conveying device due to reduced frictional wear.

According to a particularly advantageous configuration of the conveying device, the impeller forms a wall on its side facing away from the axis of rotation, wherein the impeller comprises at least one radial opening on its inner wall, via which the impeller is driven by means of a propellant medium and/or the propulsion jet, in particular in the area of a second side channel. In this way, the efficiency of the conveying device can be improved as an efficient drive of the impeller via the drive medium and/or the propulsion jet, which flows out of the radial opening of the impeller and thus drives the impeller in a direction of rotation. The propellant medium, which is in particular under high pressure and flows at a high speed out of the radial opening, flows into the area of the second side channel. The impeller is thereby offset into a rotational movement by means of a recoil drive, wherein the recoil is in particular caused by the propellant medium flowing from the at least one radial opening into the second side channel.

According to an advantageous configuration, the impeller comprises radial channels, wherein the channels extend from the area of the axial opening to the second side channel and wherein the radial channels fluidically connect the axial opening and the second side channel. In this way, the advantage can be achieved that a majority of the pressure energy and kinetic energy of the gaseous medium and/or propulsion jet injected via the metering valve, in particular the propellant medium, can be converted into rotational energy of the impeller, wherein the flow losses of the propellant medium can be reduced with the second side channel and/or the propellant medium with a radial channel. The efficiency of the conveying device and/or the side channel compressor can thus be increased.

According to a particularly advantageous further development, the radial channels are configured as open channels, wherein the respective channel is opened in the direction of the axis of rotation on the side facing away from the drive. In this way, the advantage can be achieved that the open channels connecting the axial opening to the second side channel can be introduced into the impeller by means of a simple manufacturing process. Furthermore, due to this configuration of the conveying assembly according to the present invention, the separate component disc or cover can be saved, which can reduce the material costs and/or component costs.

According to an advantageous configuration, the radial channels are configured as closed channels, wherein the respective channels are closed by means of a separate cover such that the channels are limited by the cover in the direction of the axis of rotation on the side facing away from the drive. In this way, the advantage can be achieved that a compact design is provided for the connection of the axial opening to the second side channel.

According to an advantageous further development of the conveying device, the propellant medium is at least indirectly metered into and/or flows into the second side channel via the metering valve, wherein the second side channel is at least almost completely fluidically separated from the first side channel and/or is only fluidically connected in the area of the gas outlet opening. In this way, it can be ensured that a majority of the kinetic energy of the propellant medium and the propulsion jet is used to drive the impeller and that this kinetic energy is not lost at least in part due to flow losses and/or friction losses with a recirculate located in the first side channel. In addition, there is a pressure exchange and/or momentum exchange between the propellant medium and the medium in the second side channel, wherein the propellant medium has a higher pressure and/or a higher speed in relation to the medium in the second side channel. The efficiency of the conveying device and/or the side channel compressor can thus be increased.

According to a particularly advantageous configuration of the conveying device, the impeller, in particular depending on the operating state of a fuel cell, is either driven by the drive, which can be configured as a drive motor, or at least indirectly driven by the propulsion jet from the at least one radial channel, or driven by the elements simultaneously. In this way, the drive motor of the side channel compressor can be assisted at high load points of the side channel compressor and/or the fuel cell and/or the fuel cell system by the action of the metering valve propulsion jet, which can make the drive motor and/or the impeller more compact, thereby reducing the required assembly and cost of the entire conveying device. In addition, a better efficiency of the conveying device can be achieved as the conveying device can operate more efficiently at the different operating states of the fuel cell system and/or the fuel cell.

According to an advantageous configuration of the conveying device, the at least one radial channel extends helically from the interior of the impeller to the wall. In this way, it can be ensured that the propellant medium is accelerated as much as possible during the flow of the radial channel or the open channel by rotation of the impeller in combination with the helical shape. In addition, the propulsion jet can flow out of the impeller at least almost parallel to a tangent of the internal wall or at a small angle to said wall, reducing the friction losses. Furthermore, due to the longer channel length of the radial channel, the propellant medium is subjected to the centrifugal force due to the rotating impeller for a longer period of time, wherein further increased acceleration can be achieved, which results in increased inflow speed of the propellant medium into the second side channel. In this way, the efficiency of the conveying device and/or the side channel compressor can be increased.

The invention is not limited to the embodiment examples described here and the aspects highlighted thereby. Rather, within the range specified by the disclosure, a large number of modifications are possible which lie within the abilities of a skilled person.

### BRIEF DESCRIPTION OF THE DRAWINGS

The invention is described in greater detail below in reference to the drawing.

Shown are:

FIG. 1 a schematic sectional view of a conveying device according to the invention with a recirculation fan,

FIG. 2 a schematic cross-sectional view of a part of the conveying device in accordance with a first embodiment example and a second embodiment example with a metering valve and a side channel compressor,

FIG. 3 a sectional view and/or top plan view of the conveying device, the side channel compressor and an impeller designated in FIG. 2 with A-A according to a first or a second embodiment example,

### DETAILED DESCRIPTION

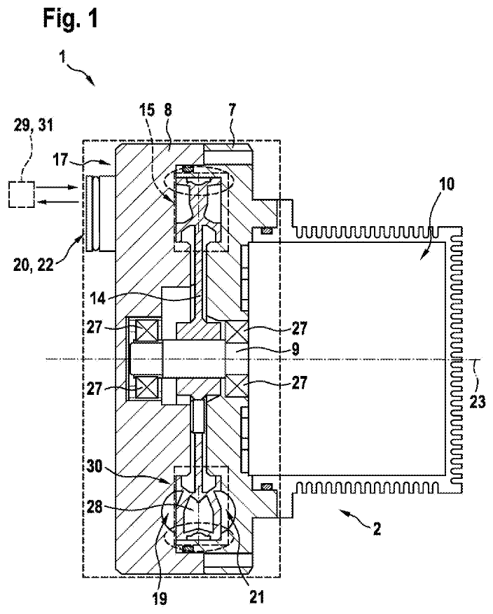

The illustration according to FIG. 1 is a schematic sectional view of a conveying device 1 according to the invention with a side channel compressor 2.

The side channel compressor 2 comprises an impeller 14 rotating in a housing 17, which is mounted on a drive shaft 9 and is rotated by a drive 10, which can be formed as a drive motor 10.

In one embodiment example, the impeller 14 can be mounted on the drive shaft 9. Alternatively, the drive motor 10 can be configured as an axial field motor 10 that does not require a drive shaft 9.

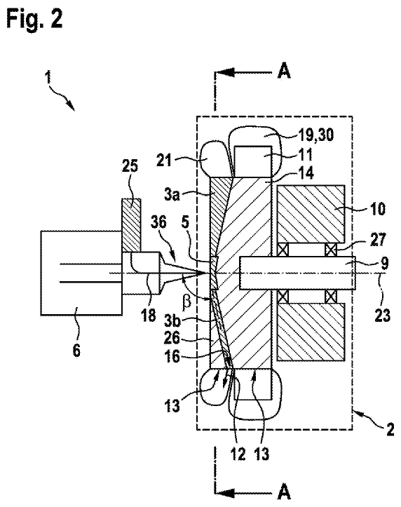

It is shown in FIG. 1 that conveying device 1 is suitable for a fuel cell system 31 for conveying and/or recirculating a gaseous medium, in particular hydrogen. The conveying device 1 comprises the side channel compressor 2, wherein the conveying device 1 can be driven at least in part by means of a metering valve 6 (shown in FIG. 2) with a propulsion jet 12 (shown in FIG. 2) of a pressurized gaseous medium. The pressurized gaseous medium is fed to the conveying 1 by means of the metering valve 6, wherein the side channel compressor 2 comprises the impeller 14, each of which is arranged rotatably about an axis of rotation 23. An anode output of a fuel cell 29 is fluidically connected to a gas inlet opening 20 of the conveying device 1. Furthermore, an anode input of a fuel cell 29 is fluidically connected to a gas outlet opening 22 of the conveying device 1.

An electric drive motor 10 serves as a rotary drive 10 of the impeller 14. Furthermore, the conveying device 1 comprises the housing 17. The housing 17 comprises a housing upper part 7 and a housing lower part 8 connected to each other. Furthermore, the impeller 14 can be arranged in a rotationally fixed manner on the drive shaft 9 and is enclosed by the housing upper part 7 and the housing lower part 8. Furthermore, the impeller 14 forms a conveying cell 28 which is connected to a hub disc on the outside. These conveying cells 28 of the impeller 14 extend circumferentially about the axis of rotation 23 in a circumferential compressor chamber 30 of the housing 17. Furthermore, FIG. 1 shows the cut contour of a respective blade 11 and/or respective blades 11 in the area of the conveying cell 28. These respective blades 11 can have a V-shaped contour, wherein the symmetrical V-shaped contour extends in the direction of the axis of rotation 23. Furthermore, the respective conveying cell 28 is limited in the direction of rotation of the impeller 14 by two respective blades 11, wherein a number of blades 11 are arranged circumferentially around the axis of rotation 23 on the impeller 14 radially to the axis of rotation 23.

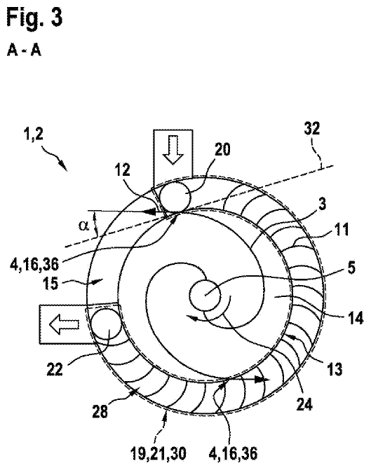

As shown in FIG. 1, the housing 17, in particular the housing upper part 7 and/or the housing lower part 8, comprises at least one circumferential side channel 19, 21 in the area of the compressor chamber 30. The at least one side channel 19, 21 in the housing 17 extends in the direction of the axis of rotation 23 such that it extends axially or radially to the conveying cell 28 on one or both sides. The at least one side channel 19, 21 can extend circumferentially around the axis of rotation 23 at least in a sub-area of the housing 17, wherein in the sub-area in which the first side channel 19 is not configured in the housing 17, a breaker area 15 can be configured in the housing 17 (see FIG. 3).

In a possible embodiment, the drive shaft 9 is connected axially to the axis of rotation 23 at least cardanically to the drive motor 10. In addition, the at least one bearing 27 is located on the outer diameter of the drive shaft 9 axially in the area between the housing lower part 8 and the impeller 14.

Furthermore, the housing 17, in particular the housing lower part 8, forms the gas inlet opening 20 and the gas outlet opening 22. The gas inlet opening 20 and the gas outlet opening 22 are fluidically connected to each other, in particular via the first side channel 19.

In the first embodiment, a torque is transferred from the drive motor 10 to the impeller 14 via the drive shaft 9. In an alternative embodiment, the drive motor 10 can be configured as an axial field motor 10, and thus drive the impeller 14 directly by means of a magnetic field without the need for torque transmission via the drive shaft 9. The impeller 14 is thereby set in rotational movement and the conveying cell 28 moves in a rotational movement circumferential about the axis of rotation 23 through the compressor chamber 30 in the housing 17 in the direction of rotation 24 (see FIG. 3) of the impeller 14. A gaseous medium, which is already in the compressor chamber 30, is also moved through the conveying cell 28 and is conveyed and/or compressed in the process. In addition, a movement of the gaseous medium, in particular a flow exchange, takes place between the conveying cell 28 and the first side channel 19. Furthermore, the side channel compressor 2 is connected to the fuel cell system 31 via the gas inlet opening 20 and the gas outlet opening 22, wherein the gaseous medium, which is in particular an unused recirculation medium from the fuel cell 29, enters the compressor chamber 30 of the side channel compressor 2 via the gas inlet opening 20 and/or is fed to the side channel compressor 2 and/or is drawn in from the region upstream of the gas inlet opening 20. The gaseous medium is discharged after it has been passed through conveying device 1 and/or side channel compressor 2 via the gas outlet opening 22 of the side channel compressor 2 and flows in particular into the fuel cell 29 via the anode output. The conveying device 1 and/or the side channel compressor 2 also comprise a housing 17 with the gas inlet opening 20 formed on the housing 17 and the gas outlet opening 22, which are fluidically connected to each other via the compressor chamber 30, in particular the at least one first side channel 19

FIG. 2 shows a schematic cross-sectional view of a part of conveying device 1 according to a first embodiment example with the metering valve 6, the side channel compressor 2 and the drive motor 10.

The conveying device 1 for conveying and/or recirculating a gaseous medium, in particular hydrogen, is shown with the side channel compressor 2. The conveying device 1 is at least partially driven by means of the metering valve 6 having a propulsion jet 12 of a pressurized gaseous medium, wherein the pressurized gaseous medium is fed at least indirectly to the conveying device 1 by means of the metering valve 6 and is present as the propellant medium. According to a particularly advantageous further development of the conveying 1, the at least one radial channel 3 runs orthogonally to the axis of rotation 23. In this way, the advantage can be achieved that a majority of the pressure energy and kinetic energy of the propulsion jet 12 provided via the metering valve 6, in particular the propellant medium, can be converted into rotational energy of the impeller 14, wherein the flow losses of the propulsion jet 12 can be reduced with the second side channel 21 and/or the propellant medium with the radial channel 3. The efficiency of conveying device 1 and/or side channel compressor 2 can thus be increased.

Furthermore, it is shown in FIG. 2 that the conveying device 1 comprises the circumferential compressor chamber 30 extending around the axis of rotation 23, which comprises at least one circumferential first side channel 19, with an impeller 14 located in the housing 17 (shown in FIG. 1), which is arranged rotatably about the axis of rotation 23 and driven by the engine 10. The compressor chamber 30 and the first side channel 19 run at least approximately annularly about the rotation axis 23. The side channel compressor 2 comprises the impeller 14, which has blades 11 arranged at its circumference in the area of the compressor chamber 30. The impeller 14 is fluidically connected to the metering valve 6 and/or a tank 25 by means of at least one radial channel 3 opening into at least one radial opening 16. The propellant medium is thereby metered from the radial channel 3 into a second side channel 21 and/or flows into it, wherein the second side channel 21 is at least almost completely fluidically separated from the first side channel 19 and/or is only fluidically connected in the area of the gas outlet opening 22.

The gaseous medium is fed via the metering valve 6 to the side channel compressor 2 via the impeller 14. The feed also takes place at least almost in the direction of the axis of rotation 23 on the side of the impeller 14 facing away from the drive 10, in particular via a nozzle 36 of the metering valve 6, which is connected to the tank 25 via an internal channel 18. The gaseous medium is fed from the metering valve 6 into the area of an axial opening 5 of the impeller 14, wherein the axial opening 5 extends in particular circumferentially around the axis of rotation 23 in a disc-shaped manner.

FIG. 2 also shows that the radial channels 3 extend from the area of the axial opening 5 to the second side channel 21 and wherein the radial channels 3 fluidically connect the axial opening 5 and the second side channel 21. In this respect, a first embodiment example is shown in FIG. 2 above the axis of rotation 23 and a second embodiment example of the conveying 1 is shown below the axis of rotation 23.

According to a first embodiment example, the radial channels 3 of the conveying device 1, in particular the impeller 14 of the side channel compressor 2, are configured as open channels 3a, wherein the respective channel 3a is opened in the direction of the axis of rotation 23 on the side facing away from the drive 10.

According to a second embodiment example, the radial channels 3 of the conveying device 1 are configured as closed channels 3b, wherein the channels 3b are closed by means of a separate cover 26 such that they are limited in the direction of the axis of rotation 23 on the side of the cover 26 facing away from the drive 10.

Furthermore, it is shown in FIG. 2 that the drive shaft 9 can be supported by means of at least one bearing 27, in particular in the housing 17 and/or on the drive motor 10. The drive shaft 9 and/or the impeller 14 and/or the at least one bearing 27 and/or the drive motor 10 are at least almost rotationally symmetrical about the axis of rotation 23. The impeller 14 can be fixed to the drive shaft 9 by means of a press fit. According to an advantageous configuration of the conveying device 1, the at least one radial channel 3 can extend at an angle ß to the axis of rotation 23. In this way, the inflow behavior of the propulsion jet 12 and/or the propellant medium into the second side channel 21 can be improved, in particular if the second side channel 21 has a flow cross-section tilted away from the first side channel 19.

In a further embodiment example of the conveying device 1, the two side channels 19, 21 are at least almost entirely fluidically separated from one another over a small part, in particular less than 50% of the distance of the compressor chamber 30 extending in the rotational direction 24. Thus, the two side channels 19, 21 in the remaining compressor chamber 30 upstream of the gas outlet opening 22 are fluidically connected to each other, wherein this distance is at least 50% of the distance of the overall distance of the compressor chamber 30 that extends around the axis of rotation 23. In this way, an improved mixing of the propellant medium with the recirculate can take place, wherein in this way, in particular, a suction jet effect is created in that the propellant medium meets the recirculate at a higher flow velocity, which flows at a lower flow velocity in the compressor chamber 30. Momentum is transferred, which creates a suction jet effect, not dissimilar to the effect in a jet pump.

In an embodiment example of the conveying device 1, the metering valve 6 and side channel compressor 2 elements are located in the housing 17 of the conveying device 1 with the drive motor 10, wherein in particular the flow contours of the metering valve 6 and the side channel compressor 2 and the channels 3, 5 connecting these two elements 2, 6 are located. Thus, no separate housing is needed for each of the side channel compressor 2 and metering valve 6 elements, but the common housing 17 can be used for all elements.

It is shown in FIG. 2 that the propellant medium, which is in particular under a high pressure, flows from the tank 25 into the internal channel 18 of a nozzle 36. The propellant medium from the tank 25 is thereby metered to the internal channel 18 via the metering valve 6. From the inner channel 18, the propellant medium continues to flow in a flow direction at least almost parallel to the axis of rotation 23 and is injected into the axial opening 5 of the impeller 14 via a nozzle 36 of the metering valve 6. The at least one radial channel 3 is orthogonal to the axis of rotation 23. In this area of the axial opening 5, the gaseous medium, which is in particular a propellant medium, is deflected such that it flows from and into the radial channel 3 at an angle ß and/or at least almost orthogonal to the axis of rotation 23 from the area of the axial opening 5. From the radial channel 3, the propellant medium flows via the respective radial opening 16 into the second side channel 21. The impeller 14 comprises at least one radial opening 16 on an internal wall 13, via which the impeller 14 is driven by means of the propellant medium. The propellant medium is at least indirectly metered into and/or flows into the second side channel 21 via the metering valve 6, wherein the second side channel 21 is at least almost completely fluidically separated from the first side channel 19 and/or is only fluidically connected in the area of the gas outlet opening 22.

FIG. 2 also shows that the separate cover 26 can be formed as a disc 26, wherein this disc 26 is connected to the impeller 14 by means of an installation step. Only by means of this cover 26 is it possible to introduce the complex structure of the at least one radial channel 3, which in particular extends away from the axis of rotation 23 in a helical-shaped manner (shown in FIG. 3).

FIG. 3 shows a sectional view and/or top view designated A-A in FIG. 2 of conveying device 1, the side channel compressor 2 and the impeller 14 according to a first or a second embodiment example. The impeller 14 comprises blades 11 arranged at its circumference in the area of the compressor chamber 30. Furthermore, it is shown that the housing 17 comprises the gas inlet opening 20 and the gas outlet opening 22 fluidically connected to each other via the compressor chamber 30, in particular the at least one first side channel 19. The recirculate is fed to the compressor chamber 30 from the anode output of the fuel cell 29 via the gas inlet opening 20. The side channel compressor 2 conveys and/or compresses the recirculate in the respective side channel 19. From there the compressed recirculate reaches the gas outlet opening 22 and from there returns to the fuel cell 29, in particular via the anode input. Between the gas inlet opening 20 and the gas outlet opening 22 is the breaker area 15 to prevent a pressure drop and/or pressure balance from the gas outlet opening 22 to the gas inlet opening 20, in particular in the direction of rotation 24. The breaker area 15 extends at least partially circumferential about the axis of rotation 23 and at least fluidically interrupts the respective side channel 19, 21.

Furthermore, the impeller 14 forms a wall 13 on its side facing away from the axis of rotation 23, wherein the impeller 14 comprises at least one radial opening 16 and/or a bore 4 on its inner wall 13, via which the impeller 14 is driven by means of a propellant medium and/or the propulsion jet 12, in particular in the area of a second side channel 21. The propulsion jet 12 extends at an angle α of at least almost 0° to 60° to a tangent 32 of the internal wall 13.

In addition, the radial channel 3 is shown forming the bore 4 in the end region facing a compressor chamber 30, but in particular only over a part of its entire length. The at least one radial channel 3 extends helically-shaped from the interior of the impeller 14 to the wall 13.

The propulsion jet 12 of the metering valve 6, wherein this is in particular a propellant medium, is introduced into the second side channel 21 at high pressure and at a high speed. A force is applied to the impeller 14 in such a way that it sets itself in motion and/or is kept in motion due to the lever arm, in particular a rotational movement. The impeller 14 rotates in the direction of rotation 24. The hydrogen flowing from the tank 25, in particular a high-pressure tank 25, through the metering valve 6 into the side channel compressor 2, which has a lower temperature in the tank 25 than the operating temperature of the side channel compressor 2, can thus be used as the incoming hydrogen, which is in particular a propellant medium, for cooling the side channel compressor 2. This reduces the probability of failure of the conveying device 1 due to heating by overtemperature.

It is further shown in FIG. 3 that the impeller 14 is either driven by the drive motor 10 or at least indirectly driven by the propulsion jet 12 of the metering valve 6 or driven by elements 6, 10, 12 simultaneously, depending on the operating state of the fuel cell 29. The flow energy contained in the hydrogen to be metered is used to drive the impeller 14 of the side channel compressor 2. The propulsion jet 12 flows into the region of the second side channel 21 and in this way drives the impeller 14. The hydrogen is fed axially to the impeller 14, guided radially outward such that the propulsion jet 12 exits the impeller 14 in the circumferential direction and thus generates a torque on the impeller 14. In order to avoid imbalance, the radial openings 16 and/or radial channels 3 are evenly distributed around the circumference.

It is further shown in FIG. 3 that the conveying cell 28 is located between two adjacent blades 11. Furthermore, the blades 11 have a symmetrical V-shaped contour, wherein the symmetrical V-shaped contour runs in the direction of rotation 23 and wherein the opened side of the symmetrical V-shaped contour of the blades 11 is directed in the direction of rotation 24 of the impeller 14.

1. A conveying device (1) for a fuel cell system (31) for conveying and/or recirculating a gaseous medium, comprising a side channel compressor (2) having a housing (17) with a gas inlet opening (20) formed on the housing (17) and a gas outlet opening (22), which are fluidically connected to one another via a compressor chamber (30), wherein the conveying device (1) is driven at least partially by a metering valve (6) having a propulsion jet (12) of a pressurized gaseous medium, and the pressurized gaseous medium being fed to the side channel compressor (2) at least indirectly by the metering valve (6); the compressor chamber (30) extends around an axis of rotation (23) in the housing (17) and has at least one circumferential side channel (19); an impeller (14) which is located in the housing (17), is rotatable about the axis of rotation (23) and is driven by a drive (10) wherein the gaseous medium is fed by the metering valve (6) to the side channel compressor (2) via the impeller (14), the feed taking place at least almost in a direction of the axis of rotation (23) on a side of the impeller (14) facing away from the drive (10).

2. The conveying device (1) according to claim 1, wherein the gaseous medium is fed from the metering valve (6) into an area of an axial opening (5) of the impeller (14).

3. The conveying device (1) according to claim 1, wherein the impeller (14) forms a wall (13) on a side facing away from the axis of rotation (23), wherein the impeller (14) comprises at least one radial opening (16) on the wall (13), via which the impeller (14) is driven by a propellant medium and/or the propulsion jet (12).

4. The conveying device (1) according to claim 14, wherein the impeller (14) comprises radial channels (3), wherein the channels (3) extend from an area of the radial opening (16) to the second side channel (21), and wherein the radial channels (3) fluidically connect the radial opening (16) and the second side channel (21).

5. The conveying device (1) according to claim 4, wherein the radial channels (3) are formed as open channels (3a), wherein the respective channel (3a) is opened in the direction of the axis of rotation (23) on the side facing away from the drive (10).

6. The conveying device (1) according to claim 4, wherein the radial channels (3) are formed as closed channels (3b), wherein the respective channels (3b) are closed by a separate cover (26) such that the channels (3b) are limited in the direction of the axis of rotation (23) on a side of the cover (26) facing away from the drive (10).

7. The conveying device (1) according to claim 14, wherein propellant medium is at least indirectly metered into and/or flows into the second side channel (21) via the metering valve (6), wherein the second side channel (21) is at least almost completely fluidically separated from the first side channel (19) and/or is only fluidically connected in an area of the gas outlet opening (22).

8. The conveying device (1) according to claim 4, wherein the impeller (14), can be configured as the drive by a drive motor 10, or at least indirectly driven by the propulsion jet (12) from at least one radial channel (3) or driven by the elements (10, 12, 6) simultaneously.

9. The conveying device (1) according to claim 4, wherein at least one radial channel (3a, b) extends helically-shaped from an interior of the impeller (14) to the wall (13).

10. A fuel cell system (31) comprising the conveying device (1) according to claim 1.

11. The conveying device (1) according to claim 1, wherein the gaseous medium is hydrogen.

12. The conveying device (1) according to claim 1, wherein the gas inlet opening (20) and the gas outlet opening (22) are fluidically connected to one another via the at least one circumferential side channel (19).

13. The conveying device (1) according to claim 2, wherein the axial opening (5) extends circumferentially around the axis of rotation (23) in a disc-shaped manner.

14. The conveying device (1) according to claim 3, wherein the at least one radial opening (16) is in an area of a second side channel (21).
